(19) United States
(12) Patent Application Publication
(10) Pub. No.: US 2018/0058974 A1
(43) Pub. Date: Mar. 1, 2018

(54) FLUID RETENTION DEVICE

(71) Applicant: Tony Casassa, Andover, MN (US)

(72) Inventor: Tony Casassa, Andover, MN (US)

(21) Appl. No.: 15/653,962

(22) Filed: Jul. 19, 2017

Related U.S. Application Data
(60) Provisional application No. 62/380,434, filed on Aug. 28, 2016.

(51) Int. Cl. G01M 3/32

(52) U.S. Cl. CPC G01M 3/3272; G01L 27/007; G01M 3/3218

(57) ABSTRACT

A fluid retention device may include a hydraulic manifold which may form or contain a vacuum conduit. A vacuum pump may be in fluid communication with the vacuum conduit. The vacuum pump may be configured generate a vacuum within the vacuum conduit. A fluid system coupler may be in fluid communication with the vacuum conduit, and the fluid system coupler may be configured to be coupled to a fluid containing system to communicate the vacuum generated by the vacuum pump into the fluid containing system to prevent redistribution of the fluid within the fluid containing system.

### CROSS REFERENCE TO RELATED APPLICATIONS

This application claims priority to and the benefit of the filing date of U.S. Provisional Application No. 62/380,434, filed on Aug. 28, 2016, entitled “VACUUM BASED DEVICE FOR HOLDING FLUID IN A SYSTEM TO PREVENT UNDESIRED FLUID LOSS DURING SERVICE AND MAINTENANCE WORK”, which is hereby incorporated by reference in its entirety.

### FIELD OF THE INVENTION

This patent specification relates to the field of devices configured to prevent undesired fluid redistribution or fluid loss in fluid containing systems. More specifically, this patent specification relates to vacuum providing devices configured to prevent undesired fluid redistribution or fluid loss in fluid containing systems such as which frequently occurs during service and maintenance work.

### BACKGROUND

When performing maintenance or service work on systems containing liquid, a frequent challenge is preventing or containing loss of liquid. During normal operation, the system is sealed to keep the liquid in the system. Periodic service and maintenance work is required to keep the system in good working order, for example to fix leaks or remove failed components for repair or replacement. When fittings are disconnected or components are removed, gravity may cause the liquid to flow out of the system through the opening. The flow rate depends on a variety of factors including the size of the opening, the distance from the top of the fluid to the opening, and the viscosity of liquid. One example is a hydraulic system used for power transmission which typically uses petroleum based fluid. It is undesirable to lose the fluid from the system because the fluid level in the system must be replenished after work is complete and the fluid can cause environmental hazards. These systems are also very sensitive to contamination from particles which can cause severe damage to expensive components. Further, these systems can contain large quantities of fluid, up to several hundred gallons.

It is possible to simply do the work and allow the liquid to drain from the opening. However, this can create a mess and can make the work more difficult, especially with a slippery liquid such as oil. For example, it is very difficult to install a plug or connect a fitting when liquid is flowing out for the opening. Further, the fluid should be captured or cleaned up, and new fluid must be added to the system to replace the loss.

To avoid making a mess, a common method is to drain the liquid from the reservoir and system into a separate container before proceeding with work. This procedure, as well as refilling the reservoir after service work is complete, requires a significant amount of time, especially for large reservoirs. Also, a container or containers commensurate with the amount of liquid in the system are required. The containers must be extremely clean and the liquid must be kept clean to prevent the fluid from contamination so it may be put back in the system after the work is complete. Alternatively, the fluid may be discarded and new fluid used to fill the system. Properly disposing of waste fluid has a cost, as well as the acquisition cost of new fluid. This cost varies depending on the type and amount of fluid, and can be significant.

Another current solution is to connect a common shop vacuum to an opening at the top of the system to counteract the force of gravity acting on the surface of the fluid. This can reduce the amount of liquid which drains from the system, but still has significant disadvantages. First, for many applications shop vacuums cannot create enough vacuum pressure to prevent liquid loss, especially when the opening is large and/or the distance from the top of the fluid to the opening is large. The hose end on the shop vacuum is not designed to form a proper seal with typical styles of reservoir openings, reducing the amount of vacuum pressure acting on the surface of the fluid. Due to the size of the shop vacuum, a hose is required to connect to the system. The pressure drop through the hose decreases the vacuum pressure at the end of the hose connected to the system. The vacuum pressure is decreased further as the shop vacuum filter becomes clogged. Shop vacuum are large and bulky as they have a tank that is not necessary when used for this task. The typical corrugated hose used on shop vacuums are prone to hold particles that can go into the reservoir and contaminate the fluid, potentially causing damage to expensive components.

These are the methods used by both large and small companies, on mobile and industrial hydraulic systems, at the factory, at repair facilities, and in the field. The difficulties, time, and cost are well known but are accepted by those that do the work. Therefore, a need exists in the field for a device to prevent fluid from draining out during temporary disconnections of the system. There is a further need for a device that is compact and powerful and configured to provide sealed connections to various types of systems.

### BRIEF SUMMARY OF THE INVENTION

A fluid retention device is provided. The device may be coupled to a fluid containing system, such as a hydraulic system, fuel delivery system, liquid food or beverage packaging or processing system, or any other system containing a fluid. Once coupled to a fluid containing system, the device may be configured to generate and communicate a vacuum into the fluid containing system to prevent redistribution of the fluid within the fluid containing system, preferably for preventing the loss of fluid from the fluid containing system when performing service & maintenance work.

In some embodiments, the device may include a hydraulic manifold which may form or contain a vacuum conduit. A vacuum pump may be in fluid communication with the vacuum conduit. The vacuum pump may be configured generate a vacuum within the vacuum conduit. A fluid system coupler may be in fluid communication with the vacuum conduit, and the fluid system coupler may be configured to be coupled to a fluid containing system to communicate the vacuum generated by the vacuum pump into the fluid containing system to prevent redistribution of the fluid within the fluid containing system.

In further embodiments, the device may include an air inlet in fluid communication with an air outlet. A venturi vacuum pump may govern the fluid communication between the air inlet and air outlet to generate a vacuum. A fluid system coupler may be in fluid communication with the venturi vacuum pump, and the fluid system coupler may be configured to be coupled to the fluid containing system to communicate the vacuum generated by the venturi vacuum pump into the fluid containing system to prevent redistribution of the fluid within the fluid containing system.

### BRIEF DESCRIPTION OF THE DRAWINGS

Some embodiments of the present invention are illustrated as an example and are not limited by the figures of the accompanying drawings, in which like references may indicate similar elements and in which:

FIG. 1—FIG. 1 depicts a front elevation view of an example of a fluid retention device according to various embodiments described herein.

FIG. 2—FIG. 2 illustrates a rear perspective view of an example of a fluid retention device according to various embodiments described herein.

FIG. 3—FIG. 3 shows a top plan view of an example of a fluid retention device according to various embodiments described herein.

FIG. 4—FIG. 4 depicts a bottom plan view of an example of a fluid retention device according to various embodiments described herein.

FIG. 5—FIG. 5 illustrates a front elevation view of an alternative example of a fluid retention device according to various embodiments described herein.

FIG. 6—FIG. 6 shows a block diagram of an example of a fluid retention device according to various embodiments described herein.

FIG. 7—FIG. 7 depicts a block diagram of another example of a fluid retention device according to various embodiments described herein.

FIG. 8—FIG. 8 illustrates a perspective view of an exemplary fluid retention device coupled to an example of a fluid containing system according to various embodiments described herein.

### DETAILED DESCRIPTION OF THE INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

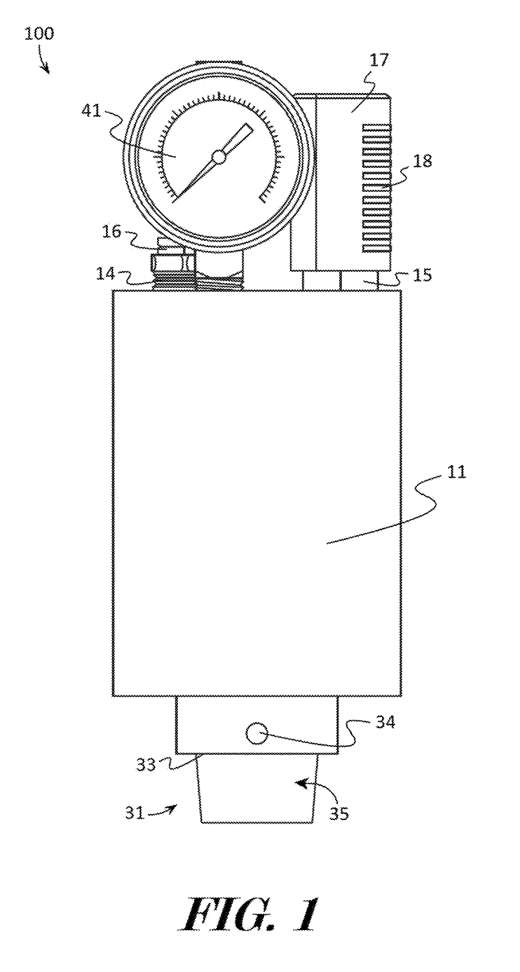

For purposes of description herein, the terms “upper”, “lower”, “left”, “right”, “rear”, “front”, “side”, “vertical”, “horizontal”, and derivatives thereof shall relate to the invention as oriented in FIG. 1. However, one will understand that the invention may assume various alternative orientations and step sequences, except where expressly specified to the contrary. Therefore, the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

Although the terms “first”, “second”, etc. are used herein to describe various elements, these elements should not be limited by these terms. These terms are only used to distinguish one element from another element. For example, the first element may be designated as the second element, and the second element may be likewise designated as the first element without departing from the scope of the invention.

As used in this application, the term “about” or “approximately” refers to a range of values within plus or minus 10% of the specified number. Additionally, as used in this application, the term “substantially” means that the actual value is within about 10% of the actual desired value, particularly within about 5% of the actual desired value and especially within about 1% of the actual desired value of any variable, element or limit set forth herein.

A new device configured to prevent undesired fluid redistribution in fluid containing systems and/or fluid loss from fluid containing systems is discussed herein. In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention, and is not intended to limit the invention to the specific embodiments illustrated by the figures or description below.

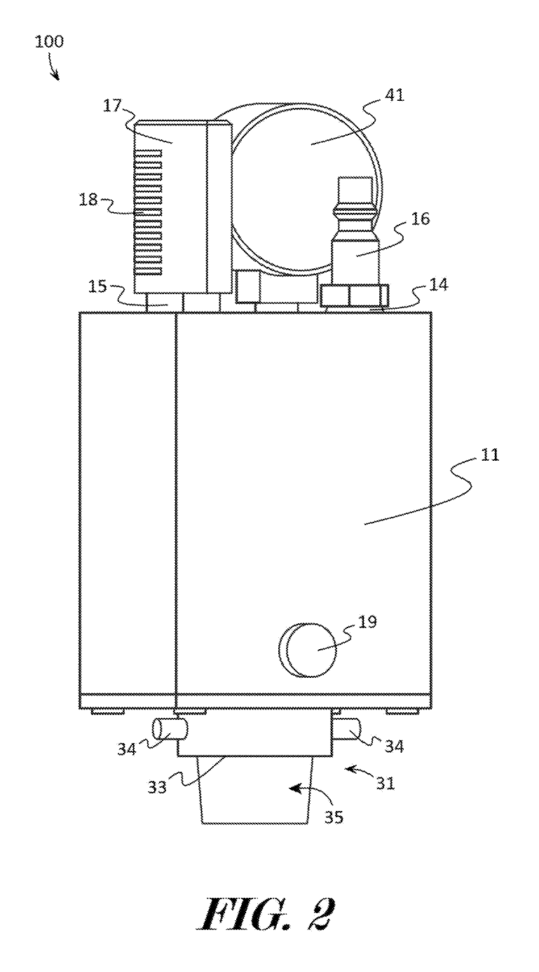

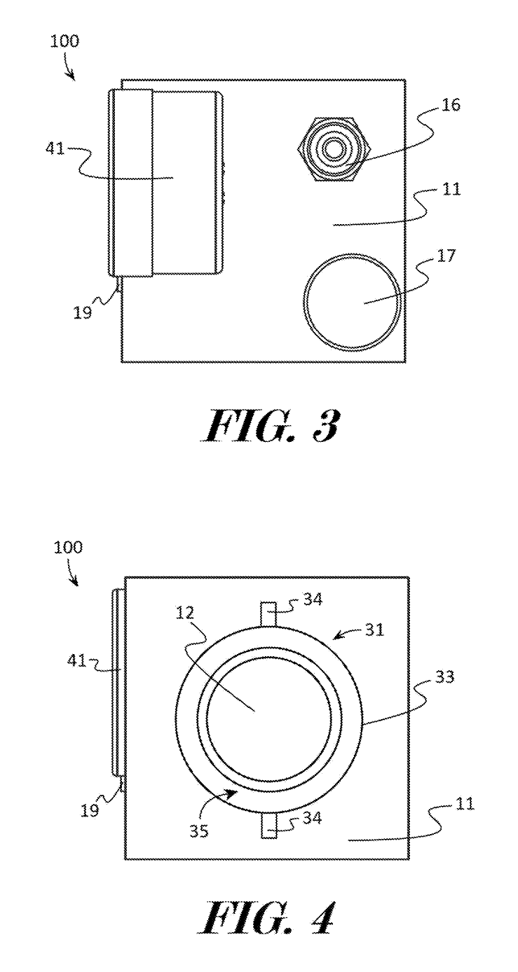

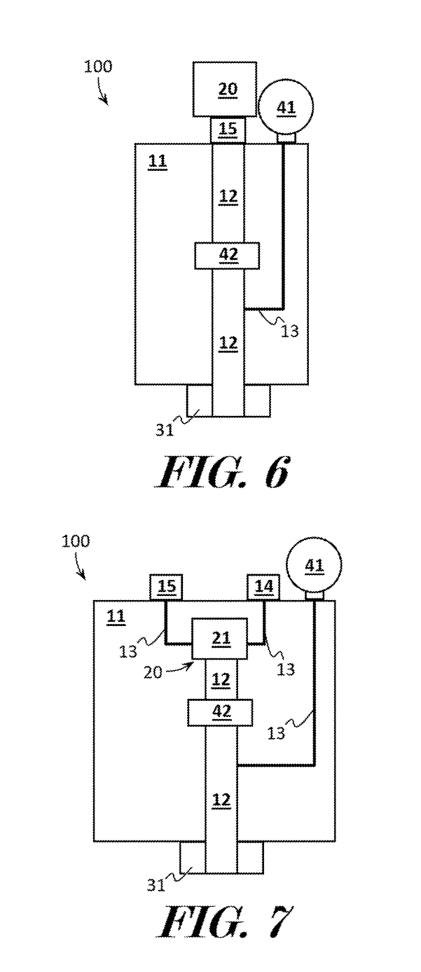

The present invention will now be described by example and through referencing the appended figures representing preferred and alternative embodiments. FIGS. 1-8 best illustrate examples of a fluid retention device (“the device”) 100 according to various embodiments. The device 100 may be coupled to a fluid containing system 200, such as a hydraulic system, fuel delivery system, liquid food or beverage packaging or processing system, or any other system containing a fluid 201. Typical fluid containing systems 200 may contain a fluid 201 dispersed in a filter 202, supply line 203, and reservoir 204 or storage tank or a variety of other components and fluid connectors. If a component of the fluid containing system 200 is removed, the fluid 201 may leak out of the fluid containing system 200 and be wasted. However, once coupled to the fluid containing system 200, the device 100 may be configured to generate and communicate a vacuum into the fluid containing system 200 to prevent redistribution of the fluid 201 within the fluid containing system 200, preferably for preventing the loss of fluid 201 from the fluid containing system 200. For example, when the device 100 is coupled to a fluid containing system 200 and communicating a vacuum into the fluid containing system 200, a filter 202 of the fluid containing system 200 may be removed, and the vacuum communicated into the fluid containing system 200 by the device 100 may prevent or minimize the remaining fluid 201 from escaping the fluid containing system 200.

In some embodiments, the device 100 may comprise a hydraulic manifold 11 which may form or contain a vacuum conduit 12. A vacuum pump 20 may be in fluid communication with the vacuum conduit 12. The vacuum pump 20 may be configured generate a vacuum within the vacuum conduit 12. A fluid system coupler 31 may be in fluid communication with the vacuum conduit 12, and the fluid system coupler 31 may be configured to be coupled to a fluid containing system 200 to communicate the vacuum generated by the vacuum pump 20 into the fluid containing system 200 to prevent redistribution of the fluid 201 within the fluid containing system 200.

In some embodiments, the device may comprise a hydraulic manifold 11 which may form a support structure upon which one or more elements of the device 100 may be coupled to and/or formed into. In further embodiments, a hydraulic manifold 11 may contain or form all or portions of a vacuum conduit 12. In preferred embodiments, a hydraulic manifold 11 may contain or form one or more auxiliary conduits 13 which may enable fluid communication between one or more elements of the device 100. A hydraulic manifold 11 may be made from or comprise durable materials such as steel alloys, aluminum, aluminum alloys, copper alloys, any other type of metal or metal alloy, various types of hard plastics, such as polyethylene (PE), polypropylene (PP) and polyvinyl chloride (PVC), polycarbonate, nylon, Poly(methyl methacrylate) (PMMA) also known as acrylic, melamine, hard rubbers, fiberglass, carbon fiber, resins, such as epoxy resin, or any other material including combinations of materials that are substantially rigid and suitable for withstanding pressures up to 10 bar and vacuums up to 29.5 in.-Hg. Additionally, it should be understood to one of ordinary skill in the art that the hydraulic manifold 11 or any other element discussed herein may be configured in a plurality of sizes and shapes including “T” shaped, “X” shaped, square shaped, rectangular shaped, cylinder shaped, cuboid shaped, hexagonal prism shaped, triangular prism shaped, or any other geometric or non-geometric shape, including combinations of shapes. It is not intended herein to mention all the possible alternatives, equivalent forms or ramifications of the invention. It is understood that the terms and proposed shapes used herein are merely descriptive, rather than limiting, and that various changes, such as to size and shape, may be made without departing from the spirit or scope of the invention.

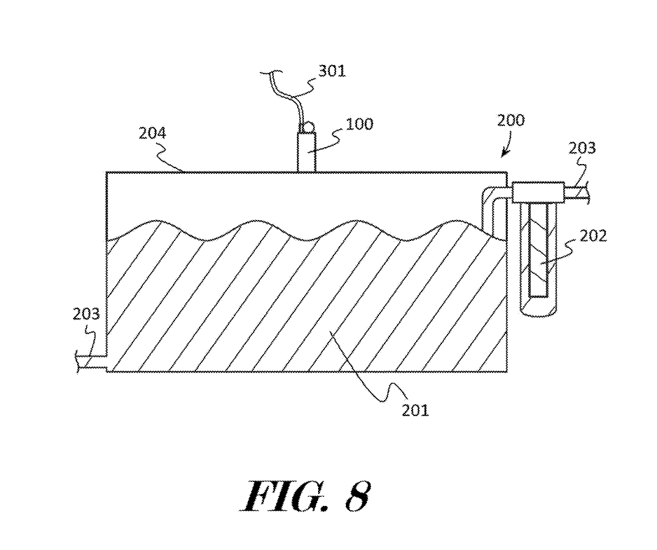

A vacuum conduit 12 may comprise any type of conduit, channel, passageway, or the like which may enable fluid communication between two or more elements of the device 100. In preferred embodiments, a vacuum conduit 12 may enable fluid communication between a vacuum pump 20 and a fluid containing system 200 (FIG. 8) to which the device 100 may be coupled. Similar to a vacuum conduit 12, an auxiliary conduit 13 may comprise any type of conduit, channel, passageway, or the like which may enable fluid communication between two or more elements of the device 100. For example, an auxiliary conduit 13 may enable fluid communication between a pressure gauge 41 and the vacuum conduit 12.

The device 100 may comprise one or more vacuum pumps 20 which may be in fluid communication with the vacuum conduit 12 and which may be configured to generate a vacuum within the vacuum conduit 12. A vacuum pump 20 may comprise a single stage or multiple stage venturi vacuum pump, also known as a vacuum generator or ejector. Optionally, a motor driven vacuum generating device such as a blower fan, a vane pump, a diaphragm pump, a liquid ring pump, a piston pump, a scroll pump, a screw pump, a Wankel pump, a roots blower or booster pump, a multistage roots pump, a Toepler pump, a lobe pump, or other suitable pump may be used. Optionally, a vacuum pump 20 may comprise a hand operated or manually operated vacuum generating pump or device. In alternative embodiments, a vacuum pump 12 may comprise a momentum transfer pump, a regenerative pump, an entrapment pump, or any other type of pump which may be suitable for generating a vacuum of approximately 0 to 29.92 in. Hg. within the vacuum conduit 12 and therefore a vacuum of approximately 0 to 29.92 in. Hg. within a fluid containing system 200 to which the device 100 is coupled. In preferred embodiments, a vacuum pump 20 may be configured for generating a vacuum of approximately 0 to 29.92 in. Hg. within the vacuum conduit 12 and therefore a vacuum of approximately 0 to 29.92 in. Hg. within a fluid containing system 200 to which the device 100 is coupled.

In preferred embodiments, a vacuum pump 20 may comprise a venturi vacuum pump 21. A venturi vacuum pump 21 may operate by creating a constriction (classically an hourglass shape) within a pipe or conduit that varies the flow characteristics of a fluid (either liquid or gas) travelling through the tube. As the fluid velocity in the constriction is increased there is a consequential drop in pressure which may be harnessed to produce a vacuum in another conduit. As perhaps best shown in FIGS. 1-3, 5, and 7, in some embodiments, the device 100 may comprise an air inlet 14 and an air outlet 15 which may both be in fluid communication each other via a venturi vacuum pump 21 and auxiliary conduits 13. The venturi vacuum pump 21 may also be in fluid communication with the vacuum conduit 12. Preferably a source of pressurized air or other fluid may be coupled to the air inlet 14 and the venturi vacuum pump 21 may govern the fluid communication of the pressurized air between the air inlet 14 and air outlet 15. The venturi vacuum pump 21 may govern the fluid communication of the pressurized air by causing a temporary constriction to increase the fluid velocity of the pressurized air to cause a drop in the pressure of the pressurized air which may be harnessed to produce a vacuum in the vacuum conduit 12.

In some embodiments, the device 100 may comprise an air inlet 14 which may be in fluid communication with the vacuum conduit 12 via an optional venturi vacuum pump 21 and an optional auxiliary conduit 13. An air inlet 14 may be coupled to the hydraulic manifold 11 and coupled to a source of pressurized fluid, such as compressed air. In preferred embodiments, an air inlet 14 may comprise a pneumatic coupling 16 which may be a quickly connected and disconnected from a source of pressurized fluid such as an air hose 301 (FIG. 8). A pneumatic coupling 16 may comprise any male or female coupling or fitting commonly found in hydraulic applications and alternative compressed gas applications, such as CEJN type fittings, Duff-Norton type fittings, Foster type fittings, Hansen 2-HKIG type fittings, Hansen 2-HKIL type fittings, Milton type fittings, Parker type fittings, Schrader Twist-Lock type fittings, Snap-Tite type fittings, Tomco type fittings, ARO Interchange Profile type fittings, Automotive Interchange Profile type fittings, Industrial Interchange Profile type fittings, Lincoln Interchange Profile type fittings, Semi-Universal Interchange Profile type fittings, or any other type of fitting or coupling. Optionally, the air inlet 14 may comprise a flange connection, barbed connection, push to connect type connection, or threaded connection such as NPT (National Pipe Thread), NPTF (National Pipe Thread Fuel), BSPP (British Standard Pipe Parallel), BSPT (British Standard Pipe Thread) or any other type of fitting or coupling.

In some embodiments, the device 100 may comprise an air outlet 15 which may be in fluid communication with the vacuum conduit 12 via an optional venturi vacuum pump 21 and an optional auxiliary conduit 13. An air outlet 15 may be coupled to the hydraulic manifold 11 and coupled directly to atmosphere or to a different low pressure area via a fluid connector. In alternative embodiments and as shown in FIG. 6, an air outlet 15 may be in direct fluid communication with the vacuum conduit 12 and a vacuum pump 20 may be coupled to the air outlet 15 and configured to remove air from the vacuum conduit via the air outlet 15. In some embodiments, an air outlet 15 may comprise any suitable channel or conduit for venting a fluid used to power a venturi vacuum pump 21. In other embodiments, air outlet 15 may comprise a pneumatic coupling which may be a quickly connected to and disconnected from a vacuum source or vacuum pump 20. In further preferred embodiments, the device 100 may comprise a silencer 17 which may be used to reduce the sound of a fluid, such as pressurized air, which may exit the device 100 via the air outlet 15. A silencer 17 may comprise any pneumatic muffler, such as sinter bronze mufflers, polypropylene mufflers, No-Clog Individual Silencers, No-Clog stacked Silencer systems, No-Clog Heavy Duty Industrial Silencers, or any other sound muffling device typically having an inlet and outlet with an expansion chamber disposed between, a sound muffling device having one or more such as a plurality of gas exit apertures 18, or any other suitable pneumatic noise reducing device.

The device 100 may comprise a fluid system coupler 31 which may be configured to couple the device 100 to a fluid containing system 200. In some embodiments, a fluid system coupler 31 may be in fluid communication with a vacuum conduit 12, and the fluid system coupler 31 may be configured to be coupled to a fluid containing system 200 to communicate the vacuum generated by the vacuum pump 20 into the fluid containing system 200. In other embodiments, a fluid system coupler 31 may be in fluid communication with a venturi vacuum pump 21, and the fluid system coupler 31 may be configured to be coupled to the fluid containing system 31 to communicate the vacuum generated by the venturi vacuum pump 21 into the fluid containing system 200.

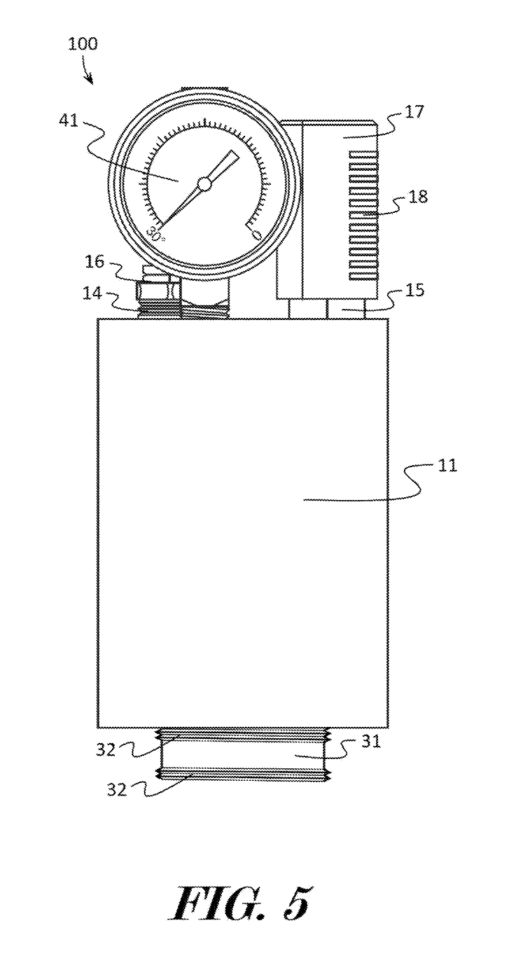

In preferred embodiments, a fluid system coupler 31 may be removably coupled to the hydraulic manifold 11 to enable one or more different sizes or types of fluid system couplers 31 to be removably coupled to the hydraulic manifold 11 so that the device 100 may be removably coupled to one or more different fluid containing systems 200 or one or more locations on fluid containing systems 200. One or more retaining fasteners 19 may be used to removably couple a fluid system coupler 31 to the hydraulic manifold 11. A retaining fastener 19 may comprise a set screw or other threaded fastener, a clasp type fastener, a clamp type fastener, a ratchet type fastener, a push-to-lock type connection method, a turn-to-lock type connection method, pinned connection method, or any other suitable temporary connection method for removably coupling a fluid system coupler 31 to the hydraulic manifold 11 or otherwise in fluid communication with a vacuum pump 20. In some embodiments, a fluid system coupler 31 may comprise threading 32 which may be used to removably couple the fluid system coupler 31 to the hydraulic manifold 11 in a threaded manner as shown in FIG. 5. In alternative embodiments, a fluid system coupler 31 may be coupled to the hydraulic manifold 11 in a generally non-removable manner, such as by being integrally formed or welded together.

In further preferred embodiments, a fluid system coupler 31 may configured to be removably coupled to a fluid containing system 200 so that the device 100 may be removably coupled to one or more different fluid containing systems 200 or one or more locations, such as to a supply line 203 or reservoir 204, on fluid containing systems 200. In some embodiments, a fluid system coupler 31 may comprise threading 32 as shown in FIG. 5 which may be used to removably couple the fluid system coupler 31 to a fluid containing system 200, preferably to a filling point on a reservoir 204, in a threaded manner. Optionally, a fluid system coupler 31 may comprise a conical surface 35 which may be inserted into a generally circular or cylindrical fill port on a fluid containing system 200 to form a seal between the fluid system coupler 31 and the fill port of the fluid containing system 200.

In other embodiments, a fluid system coupler 31 may comprise a bayonet mount 33 as shown in FIGS. 1-3 which may be used to removably couple the fluid system coupler 31 to a fluid containing system 200, preferably to a filling point on a reservoir 204, in a turn-to-lock manner. For example, a fluid system coupler 31 may comprise a male bayonet mount 33 having a cylindrical male side with one or more radial pins 34, and a fluid containing system 200 may comprise a female bayonet mount having a female receptor with matching L-shaped slot(s) and optionally spring(s) to keep the two parts locked together. The slots may be shaped like a capital letter L with serif (a short upward segment at the end of the horizontal arm) and the pin(s) 34 may slide into the vertical arm of the L, rotates across the horizontal arm, then is pushed slightly upwards into the short vertical “serif” by a spring with the fluid system coupler 31, and therefore the device 100, and fluid containing system 200 removably coupled together. In other embodiments, a fluid system coupler 31 may comprise a set screw or other threaded fastener, a clasp type fastener, a clamp type fastener, a ratchet type fastener, a push-to-lock type connection method, a turn-to-lock type connection method, pinned connection method, or any other suitable temporary connection method for removably coupling a fluid system coupler 31 to a fluid containing system 200 or otherwise in fluid communication with a vacuum pump 20. In alternative embodiments, a fluid system coupler 31 may be coupled to a fluid containing system 200 in a generally non-removable manner, such as by being integrally formed or welded together.

The device 100 may optionally comprise a pressure gauge 41 which may be configured to provide a visual indication of the pressure generated by the vacuum pump 20 that is being communicated into the fluid containing system 200 that the device 100 is coupled to. In some embodiments, a pressure gauge 41 may be coupled to vacuum conduit 12 via an auxiliary conduit 13. In other embodiments, a pressure gauge 41 may be coupled to a vacuum pump 20 or any other element of the device 100. A pressure gauge 41 may comprise any available digital and/or analogue type pressure gauge such as a hydrostatic pressure gauge, aneroid pressure gauge, piezoresistive strain gage pressure gauge, capacitive pressure gauge, magnetic pressure gauge, piezoelectric pressure gauge, optical pressure gauge, potentiometric pressure gauge, resonant pressure gauge, pressure switch, or any other pressure sensing device which may provide information describing a vacuum communicated by the device 100 to a fluid containing system 200.

The device 100 may optionally comprise a regulator valve 42 which may be configured to govern the vacuum communicated by the device 100 to a fluid containing system 200 to which the device 100 is coupled. In some embodiments, a regulator valve 42 may enable and disable the communication of vacuum from the vacuum pump 20 of the device 100 to a fluid containing system 200 to which the device 100 is coupled. In further embodiments, a regulator valve 42 may modulate the amount of vacuum communicated from the vacuum pump 20 of the device 100 to a fluid containing system 200 to which the device 100 is coupled. In further embodiments, a regulator valve 42 may modulate the air flow to or from a venturi vacuum pump 21 to modulate the amount of vacuum communicated from the venturi vacuum pump 21 of the device 100 to a fluid containing system 200 to which the device 100 is coupled. A regulator valve 42 may comprise or include a flow control valve, pressure regulating valve, relief valve, ball valve, a gate valve, butterfly valve, diaphragm valve, globe valve, check valve, pressure balanced valve, locking valve, solenoid valve, or any other type of valve or controller which may be used to enable, disable, or otherwise modulate the vacuum communicated by the device 100 to a fluid containing system 200 to which the device 100 is coupled.

While some materials have been provided, in other embodiments, the elements that comprise the device 100 such as the hydraulic manifold 11, fluid system coupler 31, and/or any other element discussed herein may be made from durable materials such as aluminum, steel, other metals and metal alloys, wood, hard rubbers, hard plastics, fiber reinforced plastics, carbon fiber, fiber glass, resins, polymers or any other suitable materials including combinations of materials. Additionally, one or more elements may be made from or comprise durable and slightly flexible materials such as soft plastics, silicone, soft rubbers, or any other suitable materials including combinations of materials. In some embodiments, one or more of the elements that comprise the device 100 may be coupled or connected together with heat bonding, chemical bonding, adhesives, clasp type fasteners, clip type fasteners, rivet type fasteners, threaded type fasteners, other types of fasteners, or any other suitable joining method. In other embodiments, one or more of the elements that comprise the device 100 may be coupled or removably connected by being press fit or snap fit together, by one or more fasteners such as hook and loop type or Velcro® fasteners, magnetic type fasteners, threaded type fasteners, sealable tongue and groove fasteners, snap fasteners, clip type fasteners, clasp type fasteners, ratchet type fasteners, a push-to-lock type connection method, a turn-to-lock type connection method, a slide-to-lock type connection method or any other suitable temporary connection method as one reasonably skilled in the art could envision to serve the same function. In further embodiments, one or more of the elements that comprise the device 100 may be coupled by being one of connected to and integrally formed with another element of the device 100.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following claims.

What is claimed is:

1. A fluid retention device for preventing the loss of fluid from a fluid containing system, the device comprising:
a. a hydraulic manifold containing a vacuum conduit;
b. a vacuum pump in fluid communication with the vacuum conduit, the vacuum pump configured to generate a vacuum within the vacuum conduit; and
c. a fluid system coupler in fluid communication with the vacuum conduit, the fluid system coupler configured to be coupled to the fluid containing system to communicate the vacuum generated by the vacuum pump into the fluid containing system to prevent redistribution of the fluid within the fluid containing system.

2. The device of claim 1, wherein the vacuum pump is selected from the group consisting of a positive displacement vacuum pump, a momentum transfer vacuum pump, a regenerative vacuum pump, and a venturi vacuum pump.

3. The device of claim 1, wherein the fluid system coupler is configured to be removably coupled to the fluid containing system.

4. The device of claim 1, wherein the fluid system coupler is removably coupled to the hydraulic manifold.

5. The device of claim 4, wherein the fluid system coupler is removably coupled to the hydraulic manifold with a retaining fastener.

6. The device of claim 1, further comprising a pressure gauge.

7. The device of claim 1, further comprising a regulator valve.

8. The device of claim 1, further comprising an air inlet in fluid communication with an air outlet, wherein the vacuum pump is a venturi vacuum pump, and wherein the venturi vacuum pump governs the fluid communication between the air inlet and air outlet.

9. The device of claim 8, further comprising a silencer coupled to the air outlet.

10. The device of claim 8, wherein the air inlet comprises a pneumatic coupling.

11. A fluid retention device for preventing the loss of fluid from a fluid containing system, the device comprising:
a. an air inlet in fluid communication with an air outlet;
b. a venturi vacuum pump governing the fluid communication between the air inlet and air outlet to generate a vacuum; and
c. a fluid system coupler in fluid communication with the venturi vacuum pump, wherein the fluid system coupler is configured to be coupled to the fluid containing system to communicate the vacuum generated by the venturi vacuum pump into the fluid containing system to prevent redistribution of the fluid within the fluid containing system.

12. The device of claim 1, wherein the fluid system coupler is configured to be removably coupled to the fluid containing system.

13. The device of claim 1, wherein the fluid system coupler comprises threading.

14. The device of claim 1, wherein the fluid system coupler comprises bayonet mount.

15. The device of claim 1, further comprising a pressure gauge.

16. The device of claim 1, further comprising a regulator valve.

17. The device of claim 1, further comprising a silencer coupled to the air outlet.

18. The device of claim 1, wherein the air inlet comprises a pneumatic coupling.

19. The device of claim 1, wherein the fluid communication between air inlet, air outlet, venturi vacuum pump, and hydraulic system coupler is provided by a hydraulic manifold.

20. The device of claim 1, wherein the fluid system coupler is removably coupled to the hydraulic manifold.
